(19) United States
(12) Patent Application Publication
(10) Pub. No.: US 2007/0209031 A1
(43) Pub. Date: Sep. 6, 2007

(54) System, Method and Medium for Providing Dynamic Model-Code Associativity

(76) Inventors: Amos Ortal, Herteliya (IL); Avraham Shalev, Bney-Barak (IL)

Correspondence Address: PILLSBURY WINTHROP SHAW PITTMAN LLP, P.O. BOX 10500, MCLEAN, VA, 22102, US

(21) Appl. No.: 11/745,331

(22) Filed: May 7, 2007

Related U.S. Application Data
(63) Continuation of application No. 10/459,712, filed on Jun. 12, 2003, now abandoned.
(60) Provisional application No. 60/387,581, filed on Jun. 12, 2002.

(51) Int. Cl. G06F 9/44

(52) U.S. Cl. 717/104

(57) ABSTRACT

A system, method and medium associates source code with a plurality of elements of a model representing the source code. Portions of computer code are associated with one or more of the model elements. The source code is modified to correspond to one or more modified model elements, and at least a portion of the source code that has been modified can optionally be displayed.

### RELATED APPLICATIONS

This application is a continuation of U.S. patent application Ser. No. 10/459,712 filed Jun. 12, 2003 which claims priority to U.S. Provisional Application No. 60/387,581 filed Jun. 12, 2002, incorporated herein by reference.

### FIELD OF THE INVENTION

Embodiments of the present invention generally relates to software engineering and, more particularly, to a system, method and medium for synchronizing or substantially synchronizing software code with a model view of the software code and/or synchronizing or substantially synchronizing a model view of the software code with software code.

### BACKGROUND OF THE INVENTION

Known conventional software development tools typically achieve model-code associativity by embedding annotations (e.g., comments) into the code and relating to the code as part of the model's repository. Although this method generally ensures consistency between the model and the code, it lacks the ability to use complex implementation schemes, such as generating accessors and/or mutators for Unified Modeling Language (UML™) relationships between classes. UML™ is a specification developed by the Object Management Group™ (Needham, Mass.).

As known, the UML™ utilizes various graphical elements that are combined into diagrams whose purpose is to provide multiple views for expressing the constructs and relationships of systems. The multiple views constitute a model, which describes what the system is supposed to do. The model does not indicate how the system is to be implemented.

A UML™ model can include nine diagrams, as follows: a class diagram, an object diagram, a use case diagram, a state diagram, a sequence diagram, an activity diagram, a collaboration diagram, a component diagram, and a deployment diagram. Not all diagrams may be required for every UML™ model. In addition, other UML™ diagrams can be derived from the basic nine diagrams (e.g., two or more diagrams, or portions thereof, can be combined to provide another diagram).

One reason for the inability of conventional systems to use complex implementation schemes lies in the fact that a single block of code cannot implement all types of UML™ model elements (e.g., a state machine), or generate, for example, accessors and/or mutators for UML™ relationships between classes. Some tools can mitigate certain limitations by automating the process of populating the model with simple constructs (e.g., attributes, operations) by, for example, adding a getter and setter to an attribute by invoking a macro on a class.

We have determined, however, that these work-around techniques result in other limitations or shortcomings. In particular, these techniques do not generally or adequately maintain the context of the additional constructs. For example, getter and setter signatures may not be updated when an attribute name is changed, which results in decreased associativity between the code and the associated model, and/or vice-versa.

FIG. 1 is as an overview of a related art software development tool as disclosed in publication U.S. 2002/0108101, which in incorporated herein by reference. As depicted in FIG. 1, source code 102 is being displayed in both a graphical form 104 and a textual form 106. The software development tool generates a transient meta model (TMM) 100 which stores a language-neutral representation of the source code 102. The graphical 104 and textual 106 representations of the source code 102 are generated from the language-neutral representation in the TMM 100. Alternatively, the textual view 106 of the source code may be obtained directly from the source code file. Although modifications made on the displays 104 and 106 may appear to modify the displays 104 and 106, in actuality all modifications are made directly to the source code 102 via an incremental code editor (ICE) 108, and the TMM 100 is used to generate the modifications in both the graphical 104 and the textual 106 views from the modifications to the source code 102.

The software development tool provides simultaneous round-trip engineering, i.e., the graphical representation 104 is synchronized with the textual representation 106. Thus, if a change is made to the source code 102 via the graphical representation 104, the textual representation 106 is updated automatically. Similarly, if a change is made to the source code 102 via the textual representation 106, the graphical representation 204 is updated to remain synchronized.

However, U.S. 2002/0108101 does not teach or suggest the code and model update procedures described herein, which achieve model-code associativity by using, for example, a mode based approach. In addition, rather than achieving model-code associativity by integrating the code as part of a repository and providing the design context by using, for example, annotations in the code as is done conventionally, one or more embodiments of the present invention provide a system, method and medium that achieves model-code associativity by using code change and/or model change detection and management.

### SUMMARY OF THE INVENTION

In accordance with one or more embodiments of the present invention, dynamic model-code associativity provides an automatic synchronization mechanism between, for example, Rhapsody's Unified Modeling Language (UML™) models and their implementation code, allowing instantaneous view of up-to-date implementation code, as well as immediate update of the model if the code is manually changed.

In at least one embodiment of the present invention, a standard browser and screen displays can be used. For example, on the right side of the screen, hand side the user can view a UML™ sequence diagram, and on the upper left side of the display the active code view can be displayed. As used herein, active code view is the area of a display that can be used to display code that corresponds to a selected model element. If the user selects, for example, a method (e.g., setup( )), the active code view can automatically update (if necessary), and display the implementation of the method setup( ).

Conversely, if the user changes the name of the method setup( ) in the sequence diagram to, for example, mySetup( ), the sequence diagram (as well as the rest of the model) automatically reflect the change.

Dynamic model-code associativity is one of the enabling features of the Rhapsody® (I-Logix Inc., Andover, Mass.) model-based approach. Chapter 15 of the Rhapsody® User Guide, Release 4.2, pages 15-1-15-53, 2003, is attached hereto as Appendix A. In this approach, the model constitutes a complete or substantially complete specification of the system from which the tool generates a series of work products such as implementation source code, various types of documents, tests scripts, UI front ends, as well as interact with external tools for various purposes such as timing analysis, test driving, etc. In to addition, model based tools are characterized by elaborate implementation schemes that aim to implement as much as possible from the UML™ specifications, including behavioral diagrams such as statechart/activity diagrams. This minimizes (or eliminates) inconsistencies between the UML™ specification and its implementation, as well as greatly increases productivity and quality of the product.

To enable end-users gain maximum benefit from the advantages offered by the programming language and the supporting technological platforms, a high or substantial degree of synergy between the model and the code is required. To provide this, the implementation language augments the modeling language, i.e. the model contains code fragments as part of its specification. In addition, the user must have a high degree of control over the generated code so it would meet its production quality requirements. Another key enabler of this synergistic approach is the ability to round-trip changes that a user has made directly to the generated code, so that user-changes to the generated code become an integral part of the model. This ensures that manual coding changes are not lost when code is regenerated. Since DMCA provides the user with the ability to immediately view and directly control the implementation of the system by utilizing standard code generation and round trip capabilities, it is one of the key facilitators for the advantages in the above approach.

Current tools achieve model-code associativity by embedding annotations into the code and relating to the code as part of the model's repository. Although this method ensures consistency between the model and the code, it lacks the ability to use complex implementation schemes. The reason for this limitation lies in the fact that we have determined, that a single block of code cannot implement all types of UML™ model elements, for example a statemachine or generating accessors and mutators for UML™ relationships between classes. Some of these tools workaround these limitations by providing automatic ways to populate the model with simple constructs (attributes, operations, etc.), for example, adding a getter and setter to an attribute by invoking a macro on the class. We have determined, however, that this results in another limitation, since usually the context of the additional constructs is not maintained: for example, a change in the attribute name will not affect the getters and setters signatures.

As we will show, our dynamic model-code associativity approach of at least one embodiment of the present invention overcomes the current art's limitation by taking a different approach: we detect changes in the model or in the code and automatically or substantially automatically make the necessary updates. This enables us to maintain and enhance our model-based approach, keeping the model separate from its implementation while maintaining a high degree of synergy between the two. In alternative implementations, the model is automatically updated based on predetermined activities and/or time intervals regardless of the types of changes requiring updating.

As described herein, the dynamic model-code associativity in accordance with at least one embodiment of the present invention updates the displayed code in case a relevant model element changes, and conversely, if the code changes, DMCA updates the model.

A high-level architecture that can implement the dynamic model-code associativity in accordance with at least one embodiment of the present invention can include a DMCAManager that is responsible for finding relevant changes in the model's repository or in the generated files, and that can invoke the proper tool for the required update. Three tools are can be utilized: A code generator for generating implementation code for model elements, a RoundTrip element that can update the repository according to the code, and an element location finder that can find where an implementation of a certain model element resides in the code so the active code view will show a relevant code fragment.

In one embodiment of the invention, there can be two relevant views for the code: code view and active code view. Both views enable text file editing, and both can send notifications to the DMCAManager that, in turn, checks if the code and the model are synchronized (see below). The active code view is a specialization of the code view. Code view allows a user to edit code for classes and/or a selected package. Thus, using code view, a user can select, for example, one or more classes, and utilize a text editor to edit the code file(s). Active code view reflects the implementation of the currently selected model element, e.g. if the user selects an element in one of the UML™ views (not shown in the figure) its implementation is immediately shown in the active code view window. Since a single file may contain several elements implementations, the element location finder can direct the active code view to scroll to the correct line in the code so the implementation of the selected element will be visible. Additional or fewer views may alternatively be used and/or combined. For example, the Code View and Active code view may optionally be combined into an additional view or an alternative embodiment.

The repository generally consists of model elements. One type of model element can be a standard Rhapsody component (I-Logix Inc., Andover, Mass.), which can hold implementation information, such as mappings between model elements and their implementation files, the type of binary file that is produced (executable, static library, DLL, etc.), makefile information, etc. Throughout a modeling session, in a preferred embodiment there is exactly one “active” component signifying the current implementation context for the code generator, the round trip tool, the DMCAManager and optionally other Rhapsody tools. In one or more alternative embodiments, the number of active components can be more than one.

It is preferred that the dynamic model-code associativity does not perform code generation unnecessarily. This can be achieved by using an IMCA (Incremental Model Code Associativity) subsystem, which can be used to determine if a model element needs to be regenerated. The IMCA is mentioned here for completeness, its structure and functionality are irrelevant for DMCA since other alternative mechanisms can be used to detect changes in model elements.

The DMCAManager can use the following algorithm to update the generated files as a result of model element change:
1. DMCAManager gets a notification that a file may need to be generated. This can be invoked by:
   1.1. The code view—when it gains focus or opens up.
   1.2. The active code view—a new selection of a model element is intercepted by the active code view, which in turn notifies the DMCAManager.
2. DMCAManager queries the active component for all the elements implemented in the file. The component holds the mapping between implementation files and model elements.
3. DMCAManager uses the IMCA to determine if any of the elements implemented in the file have been modified.
4. If there is a modified element, the DMCAManager instructs the code generator to regenerate the file.
5. If the file was regenerated, the DMCAManager notifies the code view to update itself. In case of an active code view, the active code view queries the location finder for the line numbers of the element in the code and scrolls to the proper lines (in C and C++ the active code displays header and .c\.cpp files and that is why more than single line may be involved).

The DMCAManager can use the following algorithm to roundtrip code change into the model:
1. DMCAManager may accept a notification from a code view if the view loses focus or the user saves its contents after modification. If the view loses focus and the view's content is modified, the code view saves the file and then notifies the DMCAManager.
2. If the content of the file was changed, repository update (e.g., RoundTrip) is invoked for the file and the relevant elements are updated.
3. Since the code generation mapping may be complex (for example, attributes with getters and setters) the DMCAManager invokes code generation for the modified elements so the code will comply with the code generation rules (in our example, change of the data meiber's name that is implementing the attribute will cause the names of the getters and setters to change as well).

In addition, alternative embodiments of the invention include one or more of the following:
a. The DMCAManager may optionally get a notification that a file may need to be generated from modules other than the code view or the active code view.
b. The DMCAManager may optionally use any type of mechanism to decide if a model element needs to be regenerated or optionally always regenerate the file.
c. The DMCAManager may optionally query the active component for a pointer or reference where all or substantially all the elements implemented in the file are stored.
d. The active component optionally stores an index or reference to where the mapping between implementation files and model elements is stored.
e. The DMCAManager may optionally save the file even when the view loses focus and the view's content is modified.
f. Instead of making a determination whether the content of the file was changed, repository update is optionally automatically invoked for the file and the relevant elements, if any, are updated.
g. The DMCAManager optionally invokes code generation for the all or substantially all the elements (primarily to update the modified elements) so the code will comply with the code generation rules.

Other alternatives to the above are considered within the scope of the present invention. For example, the specific sequence described above can be modified as appropriate so long as the overall DCMA functionality is performed as described herein.

In addition, examples of how one or more embodiments of the present invention can be used are as follows:
1. A user adds an attribute to a class and sets focus on the class's code view:
   a. User selects a class in the model and adds an attribute to it.
   b. User sets a focus on a code view displaying the code of this class.
   c. The code editor of the code view notifies the DMCAManager that it was selected.
   d. DMCAManager determines that the model element of the class was changed after the code was generated for the class, and therefore the file should be regenerated.
   e. DMCAManager invokes the code generator instructing it to regenerate the file.
   f. DMCAManager sends an update message to the code view, which in turn makes the code view reload the file.
2. A user renames a class and sets the focus to a view of a class that has a relation to the modified class:
   a. A user selects the class in the model and renames it.
   b. The user sets a focus on a code view displaying the code of the dependent class.
   c. The code editor of the code view notifies the DMCAManager that it was selected.
   d. The DMCAManager finds that a strong change on a directly associated element has occurred and therefore the file needs to be regenerated.
   e. The DMCAManager invokes the code generator instructing it to regenerate the file.
   f. DMCAManager sends an update message to the code view, which in turn makes the code view reload the file.
3. A user selects a model element while active code view is shown
   a. The user selects a model element.
   b. Active code view is notified of the selection.
   c. Active code view loads the file (assuming it already exists).
   d. Active code view notifies DMCAManager that the file may need to be regenerated.
   e. DMCAManager determines if the file needs to be regenerated and acts accordingly.
4. A user opens a code view of a class:
   a. The user selects a class and selects “Edit Class”.
   b. If the file does not exist it is generated. If the file exists, the code view notifies the DMCAManager that it was opened.
   c. The DMCAManager finds out if the file needs to be regenerated and instructs the code generation accordingly and if needed, makes the view reload the file.
5. A user changes a name of a class in, for example, the code or a nested class of the code, and leaves the code view:
   a. Code view saves the file and notifies the DMCAManager that the file was saved.
   b. The DMCAManager invokes RoundTrip to roundtrip the file.
   c. RoundTrip detects that the name of the class is different from the name specified in the model and changes the name of class in the model.
   d. The repository updates the dependent elements as if the user renamed the class manually.
   e. Code generator is invoked re-synchronizing the code with the model. For example the constructors and destructors are renamed properly.

Thus, the present invention advantageously, in at least one embodiment, maintains a software model, separate from its code implementation, while maintaining associativity between the two. With the system, method and medium of dynamic model-code associativity (DMCA) in accordance with at least one embodiment of the present invention, the model constitutes a complete or substantially complete specification of the system from which a code generator can generate, for example: implementation source code, various types of documents, test scripts, user interface front ends and/or can interact with external tools for various purposes such as timing analysis and/or test driving. In addition, at least one embodiment of the present invention can utilize the Unified Modeling Language (UML™), which provides a high or substantial degree of synergy between the UML™ model and the code. In addition, the implementation language (e.g., C++, Java) can augment the modeling language. For example, in an embodiment, the model can contain code fragments as part of its specification.

An embodiment of the present invention advantageously provides a user with a high degree of control over the generated code so it can meet, for example, production quality requirements. For example, at least one embodiment of the present invention can also round-trip changes, made directly to the generated code, into the model so that these changes to the code become an integral part of the model. This advantageously ensures that the model is updated, responsive to, for example, regeneration of code. One or more embodiments of the present invention can thus provide a user with the ability to quickly view and directly control and/or edit the implementation of the system by utilizing standard code generation and round trip capabilities.

One or more embodiments of the present invention can thus be utilized to detect changes in (or to) a software model and/or software code, and automatically or substantially automatically update the model and/or code. In alternative implementations, the software model can be automatically updated based, for example, on predetermined activities and/or time intervals, optionally independent of the types of changes requiring updating.

At least one embodiment of the present invention thus achieves model-code associativity using, for example, a mode based approach, and provides a system, method and medium that achieves model-code associativity by using code change and/or model change detection and management.

The present invention can also advantageously enable model-code associativity for complex code generation and round trip schemes. The present invention can thus enable a user to advantageously utilize the strength of model-based development (e.g., utilizing UML™), in combination with a substantial degree of visibility and control over the implementation code.
In accordance with an embodiment of the invention, a computer implemented method for associating source code with a plurality of elements of a model representing the source code is provided. The method can include the steps of generating a plurality of elements of a model implementable as software source code, generating the software source code corresponding to the plurality of elements of the model, associating portions of the software source code with at least one of the plurality of elements of the model, determining that at least one of the plurality of elements has been modified, and modifying the source code to correspond to at least one or more of the plurality of elements that has been modified.

The method can also optionally include the step of displaying at least a portion of the source code that has been modified. At least a portion of the model elements can be displayed in a first display region of a browser, and at least a portion of the modified source code can be displayed in a second display region of the browser. The first and second display regions can optionally be conventional browser frames.

In addition, particular line numbers of the source code can be associated with the model elements, such as unified modeling language (UML™) model elements. The UML™ elements can be at least one of a class diagram, an object diagram, a use case diagram, a state diagram, a sequence diagram, an activity diagram, a collaboration diagram, a component diagram, and/or a deployment diagram.

Another method in accordance with an embodiment of the present invention can associate source code with a plurality of elements of a model representing the source code. The method can include the steps of generating a plurality of elements of a model implementable as software source code, generating the software source code corresponding to the plurality of elements of the model, associating portions of the software source code with at least one of the plurality of elements of the model, determining that at least a portion of the source code has been modified, modifying at least one of the plurality of model elements to correspond to the modified software source code, and regenerating the software source code in accordance with predetermined rules so that the software source code conforms to the modified model.

The method according can also include the steps of displaying at least a portion of the software source code that has been modified and/or displaying at least one of the plurality of elements of the model that has been modified.

At least one of the plurality of model elements can be displayed in a first display region of a browser, and at least a portion of the modified software source code can be displayed in a second display region of the browser. The first and second display regions can be conventional web browser frames.

In addition, particular line numbers of the software source code can be associated with at least one of the plurality of model elements. The model elements can be unified modeling language (UML™) model elements that include a class diagram, an object diagram, a use case diagram, a state diagram, a sequence diagram, an activity diagram, a collaboration diagram, a component diagram, and/or a deployment diagram.

A computer program product residing on a computer readable medium in accordance with the present invention can include instructions that cause a computer to generate a plurality of elements of a model implementable as software source code, generate software source code corresponding to the plurality of elements of the model, associate portions of the software source code with at least one of the plurality of elements of the model, determine that at least one of the plurality of elements of the model has been modified, and modify the source code to correspond to the one or more modified model elements. The medium can also include instructions for causing the computer to display at least a portion of the source code that has been modified.

Another computer program product in accordance with the present invention can include instructions for causing a computer to generate a plurality of elements of a model implementable as software source code, generate software source code corresponding to the plurality of elements of the model, associate portions of the software source code at least one of the plurality of elements of the model, determine that at least a portion of the software source code has been modified, modify the at least one of the plurality of model elements to correspond to the modified source code, and regenerate the software source code in accordance with predetermined rules so that the source code conforms to the modified model. In addition, the computer program product can also include instructions for causing a computer to display at least a portion of the source code that has been modified.

A data processing system for generating documentation for source code in a software project in accordance with the present invention can include means for generating a plurality of elements of a model implementable as software source code, means for generating software source code corresponding to the plurality of elements of the model, means for associating portions of the software source code with at least one of the plurality of elements of the model, means for determining that at least one of the plurality of elements of the model has been modified, and means for modifying the software source code to correspond to one or more of the modified model elements. In addition, the data processing system can also include means for displaying at least a portion of the source code that has been modified.

A computer implemented method for associating source code with a plurality of elements of a model representing the source code in accordance with at least one embodiment of the present invention can include the steps of generating a plurality of elements of a model implementable as software source code, generating software source code corresponding to the plurality of elements of the model, associating portions of the software source code with at least one of the plurality of elements of the model, determining that at least a portion of the software source code has been modified, modifying the at least one of the plurality of model elements to correspond to the modified software source code, and regenerating the software source code in accordance with predetermined rules so that the source code conforms to the modified model. The computer implemented method can also include the step of displaying at least a portion of the source code that has been modified.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

The various features of novelty which characterize the invention are pointed out with particularity in the claims annexed to and forming a part of this disclosure. For a better understanding of the invention, its operating advantages and the specific objects attained by its uses, reference should be made to the accompanying drawings and descriptive matter in which there is illustrated preferred embodiments of the invention.

### Notations And Nomenclature

The detailed descriptions which follow may be presented in terms of program procedures executed on computing or processing systems such as, for example, a stand-alone computing machine, a computer or network of computers. These procedural descriptions and representations are the means used by those skilled in the art to most effectively convey the substance of their work to others skilled in the art.

A procedure is here, and generally, conceived to be a sequence of steps leading to a desired result. These steps are those that may require physical manipulations of physical quantities (e.g., combining various pharmaceutical products into packages). Usually, though not necessarily, these quantities take the form of electrical, optical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices, including, but not limited to, microprocessors.

### BRIEF DESCRIPTION OF THE DRAWINGS

The detailed description of the present application showing various distinctive features may be best understood when the detailed description is read in reference to the appended drawing in which:

FIG. 1 is as an overview of a related art development tool;

FIG. 2 is an exemplary screen display showing a model view and active code view;

FIG. 3 is an exemplary screen display demonstrating how the model can be updated based on a change in code;

FIG. 4 is an exemplary high-level overview of an architecture of an embodiment of the present invention;

FIG. 5 is an exemplary flow diagram showing how a code-file can be updated based on a change to the associated model;

FIG. 6 is an exemplary flow diagram showing how a model can be updated based on a change to the associated code-file;

FIG. 7 shows a block diagram of a computer that can be used to implement the dynamic model-code associativity in accordance with the present invention; and

FIG. 8 illustrates a block diagram of the internal hardware of the computer of FIG. 7.

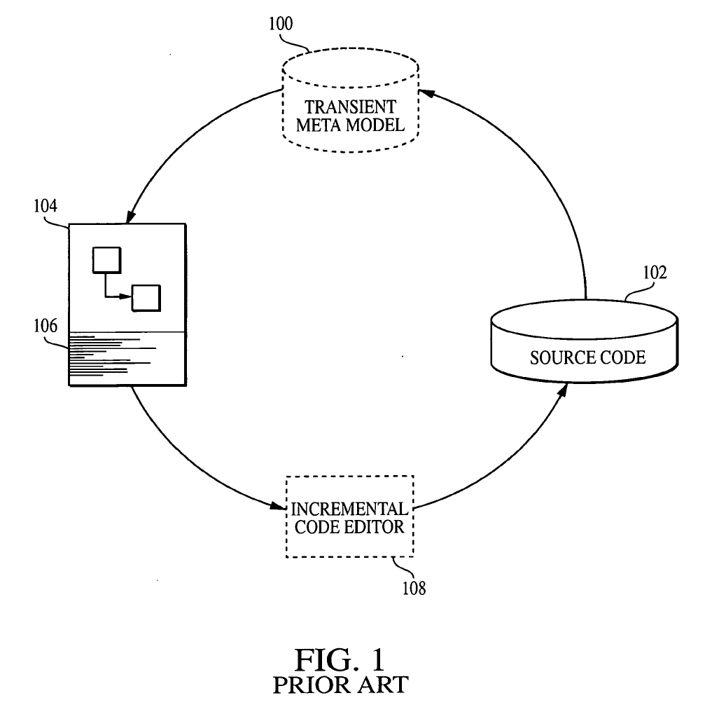

### DETAILED DESCRIPTION OF THE INVENTION

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

In accordance with a preferred embodiment, the system, method and medium of dynamic model-code associativity in accordance with the present invention provides synchronization between a model of source code and the source code itself. In at least one embodiment, the present invention thus advantageously provides or facilitates substantially instantaneous viewing of up-to-date implementation code and/or one or more associated models.

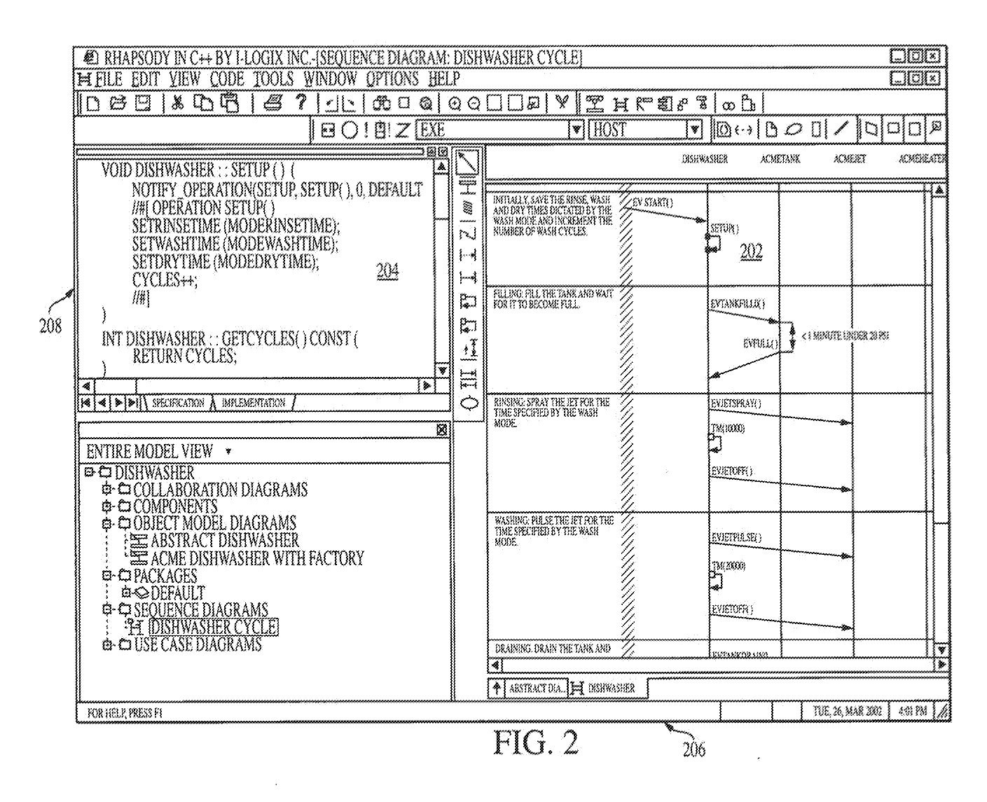

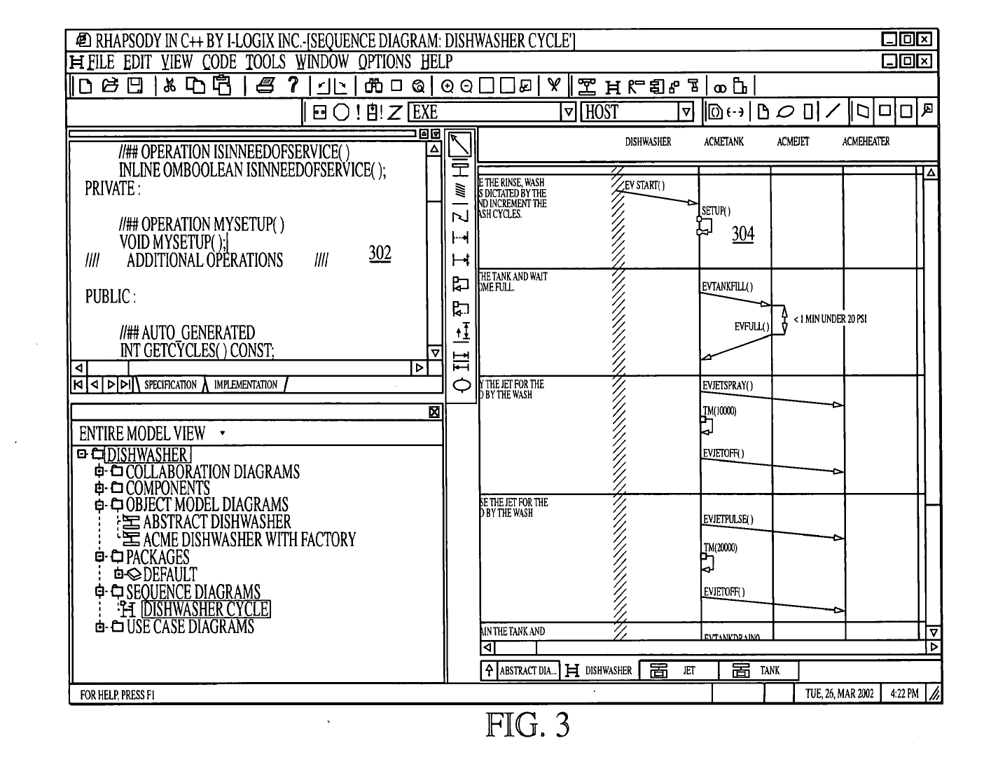

FIGS. 2 and 3 demonstrate the dynamic model-code associativity in accordance with one embodiment of the invention. As shown at 206, a browser or other standard display means can display a Unified Modeling Language (UML™) sequence diagram. It should also be understood that the present invention can also utilize and display UML™ diagrams such as class diagrams, object diagrams, use case diagrams, state diagrams, activity diagrams, collaboration diagrams, component diagrams, and/or deployment diagrams, and/or variations and/or combinations thereof. The user interface (e.g., a browser) that can be used in connection with the present invention can enable a user to create, edit and/or deleted any UML™ diagrams described above. At 208, an active code view is shown. As used herein, active code view 208 is the area of a display that can be used to display code that corresponds to a selected model element. If a user selects the method setup( ) 202, the active code view 208 can automatically update (as necessary), and display the implementation of the methodsetup( ) 204.

In addition, and referring now to FIG. 3, if the user changes the name of the method setup( ) to mySetup( ) 302, the sequence diagram (and preferably any other views of the model, as discussed above) is automatically updated to reflect the change. Thus, at 304, mySetup( ) is displayed.

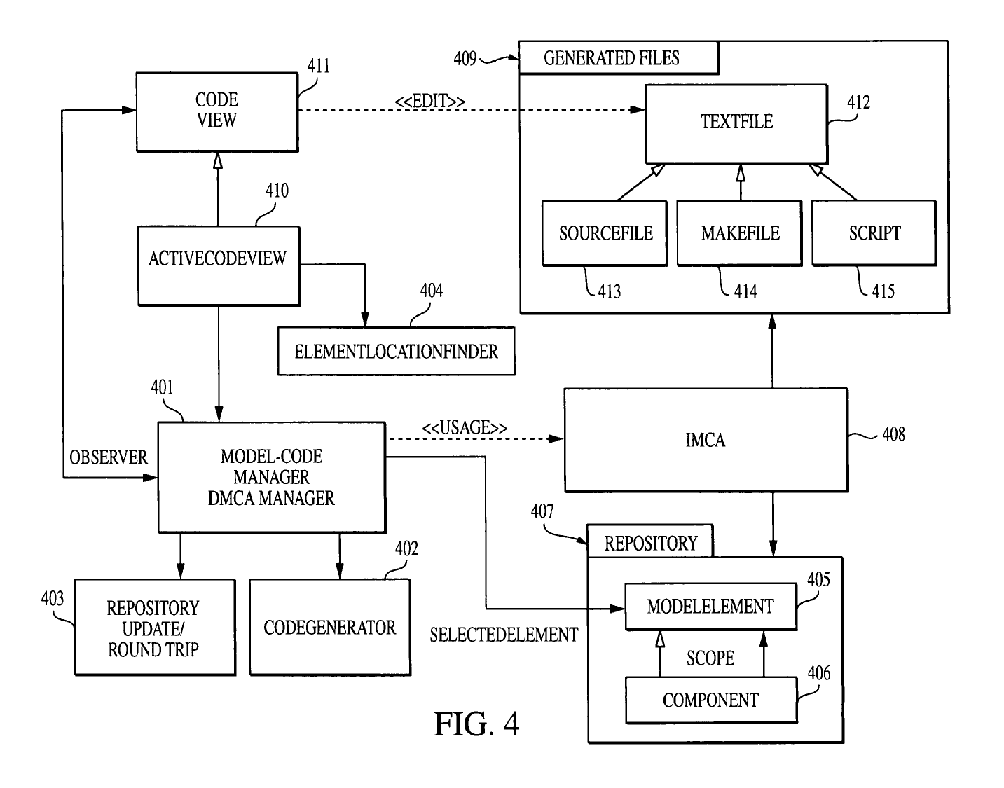

FIG. 4 shows an exemplary high-level architecture of an embodiment of the present invention. Model-code manager 401 locates or determines relevant changes in model repository 407 and/or in code generator 409. Upon determining changes to the model and/or file, model-code manager 401 can invoke one or more of, for example, three tools to accomplish the required update. In particular, model-code manager 401 can invoke code generator 402 to, for example, generate implementation code corresponding to the elements stored by and/or associated with for model element 405. Model-code manager 401 can also optionally invoke code generator 402 for all or substantially all elements (primarily to update the modified elements) stored or associated with model element 405, so the code in file 412, 413, 414, 415 will comply with the code generation rules.

Model-code manager 401 can also optionally invoke repository update 403 to, for example, update repository 407 to conform with the code. Model code manager 401 can also optionally invoke element finder 404 to, for example, determine where an implementation of a certain model element stored by and/or associated with model element 405 is located in the code. Once the model element is located, active code view 410 can be invoked to display a relevant code fragment (such as shown at FIG. 2, 208).

Code view 411 can be used to display particular implementation files 412, which can include existing source code files 413, make file 414 (e.g., one or more newly created source code files) and/or script files 415.

Both active code view 410 and code view 411 enable text file 412 editing (e.g., editing of source file 413, makefile 414 and/or script file 415), and send notifications to model-code manager 401. Active code view 410 can be a particular implementation of code view 411. In an embodiment of the present invention, model-code manager 401 may optionally receive a notification that a file 412, 413, 414, 415 may need to be generated from modules other than code view 411 or active code view 410. Code view 411 and active code view 412 may optionally be combined into an additional view or an alternative embodiment.

Active code view 410 reflects the implementation of the currently selected model element 405. For example, if a user selects an element in one of the UML™ views (e.g., mySetup 304 shown in FIG. 3), its implementation can be displayed, for example, in active code view window 208. Since a single file may contain an implementation of one or more elements, element location finder 404 can be used to direct active code view 410 to, for example, scroll to the correct line in the code so the implementation of the selected element can be displayed, for example, in active code view window 208.

An embodiment of repository 407 can include model elements 405. One type of model element 405 can be a standard Rhapsody component (I-Logix Inc., Andover Mass.), which can hold implementation information such as mappings between model elements 405 and their corresponding implementation file(s), the type of binary file that is produced (executable, static library, dynamic link library, etc.), makefile 414 information, etc. Throughout a modeling session, in one embodiment of the present invention there is one “active” component signifying the current implementation context for code generator 402, repository update 403, model-code manager 401, and optionally other tools. In an alternative embodiment, the number of active components can be more than one.

In one embodiment, model-code manager 401 can communicate with or access IMCA (Incremental Model Code Associativity) 408 to determine if there have been changes in or to an element stored by or associated with model element 405 since, for example, the last update. If there have been changes in an element stored by or associated with model element 405, model-code manager 401 can invoke repository update 403 to update or create the file(s) 412. In an embodiment of the invention, instead of making a determination whether the content of file 412, 413, 414, 415 was changed, repository update 403 is optionally automatically invoked for the file 412, 413, 414, 415 and the relevant (or associated) elements, if any, stored or associated with model element 405, are updated.

Model-code manager 401 may optionally use any type of mechanism to determine whether an element stored by or associated with model element 405 needs to or should be regenerated, or optionally always regenerates model element 405. In addition, model-code manager 401 may optionally query component 406 for, e.g., a pointer or reference indicating where particular, all or substantially all elements implemented in model element 405 are stored. In addition, component 406 can optionally store, for example, an index or reference indicating a mapping between files 412, 413, 414, 415 and elements stored by or associated with model element 405.

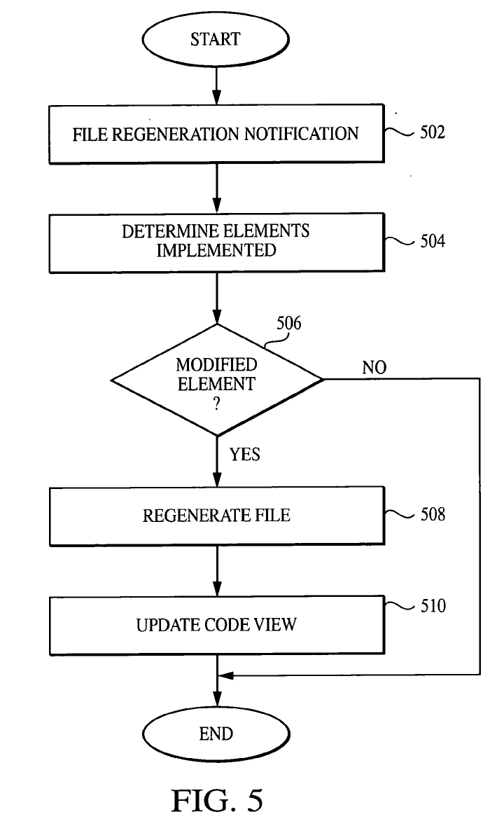

FIG. 5 is an exemplary flow diagram of a code-file update procedure related to a change to one or more model elements stored by or associated with model element 405. At step 502, model-code manager 401 can receive a notification that a file 412, 413, 414, 415 may need to be updated or generated. Model-code manager 401 can be notified by code view 411 when, for example, code view 411 gains focus (e.g., opens a file). In addition, model-code manager 401 can be notified when active code view 410 detects, for example, a new selection of model element 405.

At step 504, model-code manager 401 can query component 406 for elements implemented in a particular file 412, 413, 414, 415. Component 406 maintains or stores the mapping between files 412, 413, 414, 415 and associated or corresponding model element stored by or associated with model element 405.

At decision step 506, model-code manager 401 can invoke or access IMCA 408 to determine if any of the elements implemented in file 412, 413, 414, 415 have been modified. If no elements have been modified, the process ends. If there is a modified element, code generator 402 can be used at step 508 to regenerate file(s) 412, 413, 414, 415. In an embodiment, model-code manager 401 can instruct or cause code generator 402 to generate code. In addition, model-code manager 401 can notify, cause or instruct code view 411 to update itself. In case of active code view 410, active code view 410 can query element location finder 404 for, e.g., the line number(s) of a particular element in the code, and scroll to the proper line(s), as shown at 208 in FIG. 2.

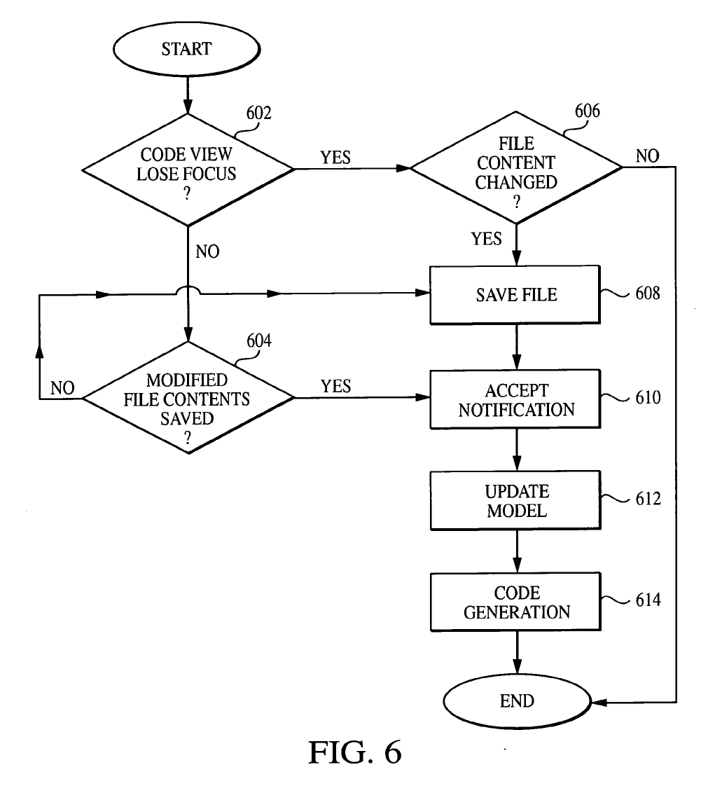

FIG. 6 is an exemplary flow diagram of a model update procedure related to a change to a file 412, 413, 414, 415. In an embodiment of the present invention, model-code manager 401 can use the following exemplary algorithm to update the model elements maintained or stored by model element 405.

At decision step 602, a determination is made whether code view 411 loses focus (e.g., the file is closed, or editing capability of the file is otherwise lost) of a file 412, 413, 414, 415. If focus is lost, code view 411 at decision step 606 can determine whether the file 412, 413, 414, 415 contents have changed. If the file contents have changed, then the file is saved at step 608. At step 610, model-code manager 401 can accept a notification from, for example code view 411 that file 412, 413, 414, 415 contents have changed. At step 612, model element 405 is updated to correspond with the content of the code saved at step 608. At step 614, model-code manager 401 invokes code generator 402 to ensure that the code complies with the code generation rules. For example, in the Java language, code generator 402 can ensure that the names of getters and setters are changed in connection with other changes to the code. If at decision step 606 it is determined that the contents of file 412, 413, 414, 415 have not changed, the process ends.

If at decision step 602 it is determined that code view 411 has not lost focus, a determination is made at decision step 604 to determine if the file 412, 413, 414, 415 has been saved. If it is determined that the file has not been saved, the file is saved at step 608, and steps 610, 612 and 614 are carried out as previously described. If it is determined at decision step 602 that the file has been saved, steps 610, 612 and 614 are carried out as previously described.

The following are exemplary illustrations of usage of the present invention. First, suppose a user desires to add an attribute to a class and set focus on the class's code view. To do this, the user can select a class in the model stored by or associated with model element 405, and add, for example, an attribute to it. A user can set a focus on a code view, displaying the code of the class. The code editor of code view 411 can notify model-code manager 401 that it was selected. Then, using, for example, the method described with regard to FIG. 5, model-code manager 401 can determine whether one or more model elements, stored in or associated with model element 405, of the class were changed after code generator 402 generated code for the class, and whether the file 412, 413, 414, 415 should be regenerated. If a model element has been changed, model-code manager 401 can invoke code generator 402, instructing it to regenerate one or more files 412, 413, 414, 415 associated with the model. Model-code manager 401 can also send an update message to code view 411, which in turn causes code view 411 reload the file 412, 413, 414, 415.

As a second example, a user can rename, for example, a class and set the focus to a view of a class that has a relation to the modified class. In particular, a user can select a class in the model that may be stored or associated with model element 405, and rename the class. The user can set a focus on a code view 411 to display the code of a dependent class. A code editor that can be utilized in conjunction with code view 411 can notify model-code manager 401 that code view 411 has been selected. Using the method as shown and described in connection with, for example, FIG. 5, model-code manager 401 can determine that a strong change (e.g., an authorized change or a change that can affect other model elements or code objects) has occurred on a directly associated element, and that the file 412, 413, 414, 415 needs to be regenerated. Model-code manager 401 can invoke code generator 402, causing or instructing code generator 402 to regenerate file 412, 413, 414, 415. Model-code manager 401 can send an update message to code view 411, which in turn instructs or causes code view 411 to reload file 412, 413, 414, 415, which can then optionally be displayed.

As a third example, a user can select an element stored or associated with model element 405, while active code view 410 is shown, such as shown in FIG. 2, at active code view 208. In particular, when a user selects a model element, active code view 405 is notified of the selection, and can load or optionally create one or more files 412, 413, 414, 415. Active code view 410 can notify model-code manager 401 that the file(s) 412, 413, 414, 415 may need to be regenerated. Model-code manager 401 can determine if the file 412, 413, 414, 415 needs to be regenerated, and regenerates one or more files 412, 413, 414, 415, optionally in a manner such as described with regard to FIG. 5.

As a fourth example, a user can open a code view 411 of a class. In particular, a user can select a class for editing. If a file 412, 413, 414, 415 for the class does not exist, code generator 402 can generate a file 412, 413, 414, 415. If one or more files 412, 413, 414, 415 exist for the class, code view 411 can notify model-code manager 401 that the file 412, 413, 414, 415 has been opened. In accordance with, for example, the method described in FIG. 5, model-code manager 401 can determine if file 412, 413, 414, 415 needs to be regenerated, and instructs code generator 402 accordingly. Model-code manager 401 can also optionally cause code view 411 and/or active code view 410 to reload the file, and subsequently display the regenerated code.

As a fifth example, a user can change the name of a class in the code and exit code view 411. In particular, code view 411 can save the file 412, 413, 414, 415 and notify model-code manager 401 that the file 412, 413, 414, 415 has been modified and saved. Model-code manager 401 can invoke repository update 403, which can detect that the name of the class is different from the name specified in the model element 405, and cause the name of class to be changed in model element 405. Repository update 403 can be invoked after code generator 402 generates code, as well as after a user makes changes to generated code. Repository 407 can update any dependent elements, optionally as if the user manually renamed the class. Code generator 402 is invoked to re-synchronize the code in file 412, 413, 414, 415, with the model elements stored in or associated with model element 405. For example, in the Java programming language, constructors and finalizers can be properly renamed. In the C++ programming language, constructors and destructors can be properly renamed.

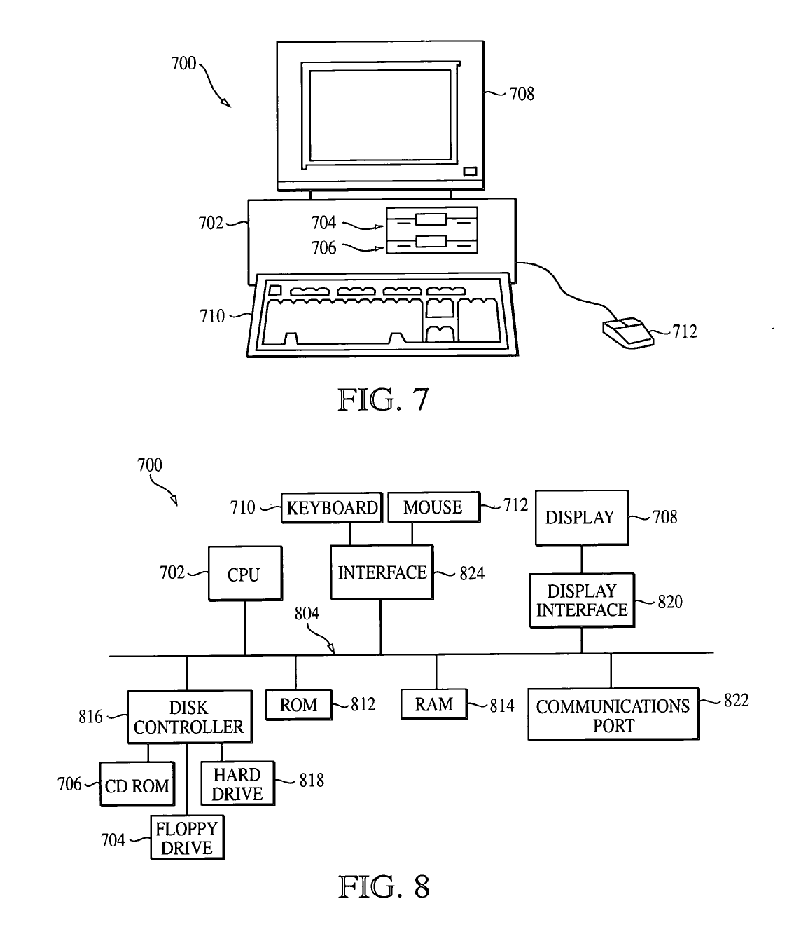

FIG. 7 is an illustration of a computer 700 used for implementing the computer processing in accordance with a computer-implemented embodiment of the present invention. The procedures described above may be presented in terms of program procedures executed on, for example, a computer or network of computers.

Viewed externally in FIG. 8, computer 700 has a central processing unit (CPU) 702 having disk drives 704, 706. Disk drives 704, 706 are merely symbolic of a number of disk drives that might be accommodated by computer 700. Typically, these might be one or more of the following: a floppy disk drive 704, or a CD ROM or digital video disk, as indicated by the slot at 706. The number and type of drives varies, typically with different computer configurations. Drives 704, 706 are, in fact, options, and for space considerations, may be omitted from the computer system used in conjunction with the processes described herein.

Computer 700 also has a display 708 upon which information may be displayed. The display is optional for the computer used in conjunction with the system described herein. A keyboard 710 and/or a pointing device 712, such as a mouse 712, touch pad control device, track ball device, or any other type of pointing device, may be provided as input devices to interface with central processing unit 702. To increase input efficiency, keyboard 710 may be supplemented or replaced with a scanner, card reader, or other data input device.

FIG. 8 illustrates a block diagram of the internal hardware of the computer of FIG. 7. Bus 804 serves as the main information highway interconnecting other components of the computer. It is connected by an interface 806 to the computer 700, which allows for data input through the keyboard 710 or pointing device, such as a mouse 712.

CPU 702 is the central processing unit of the system, performing calculations and logic operations required to execute a program. Read only memory (ROM) 812 and random access memory (RAM) 814 constitute the main memory of the computer.

Disk controller 816 interfaces one or more disk drives to the system bus 804. These disk drives may be floppy disk drives such as 704, or CD ROM or DVD (digital video/versatile disk) drives, as at 706, or internal or external hard drive(s) 818. As previously indicated these various disk drives and disk controllers are optional devices.

A display interface 820 permits information from bus 804 to be displayed on the display 708. Again, as indicated, the display 708 is an optional accessory, as would be, for example, an infrared receiver and transmitter (not shown). Communication with external devices can occur using communications port 822.

Conventional processing system architecture is more fully discussed in Computer Organization and Architecture, by William Stallings, MacMillan Publishing Co. (3d ed. 1993). Conventional processing system network design is more fully discussed in Data Network Design, by Darren L. Spohn, McGraw-Hill, Inc. (1993). Conventional data communications is more fully discussed in Data Communications Principles, by R. D. Gitlin, J. F. Hayes, and S. B. Weinstain, Plenum Press (1992), and in The Irwin Handbook of Telecommunications, by James Harry Green, Irwin Professional Publishing (2d ed. 1992). Each of the foregoing publications is incorporated herein by reference.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the user's computer may include a personal computer, a general purpose computer, or a specially programmed special purpose computer Likewise, the device application may execute on an embedded system, or even a general purpose computer or specially programmed dedicated computer closely connected to and/or controlling the device. Either of these may be implemented as a distributed computer system rather than a single computer. Similarly, the present invention can be used in a network such as the Internet, an Intranet, the World Wide Web, a modem over a POTS line, and/or any other method of communicating between computers and/or devices. Moreover, the processing could be controlled by a software program on one or more computer systems or processors, or could even be partially or wholly implemented in hardware, or could be partly embedded within various devices.

This invention is not limited to use in connection with, for example, particular types of devices with embedded systems. Further, the invention is not limited to particular protocols for communication. Any appropriate communication protocol may be used with the meter devices.

The user displays may be developed in connection with HTML display format. Although HTML is the preferred display format, it is possible to utilize alternative display formats for displaying reports and obtaining user instructions. The invention has been discussed in connection with particular examples. However, the principals apply equally to other examples. Naturally, the relevant data may differ, as appropriate.

Further, this invention has been discussed in certain examples as if it is made available by a provider to a single customer with a single site. The invention may be used by numerous customers, if preferred. Also, the invention may be utilized by customers with multiple sites and/or users. In addition, other alternatives to the above are considered within the scope of the present invention. For example, the specific sequence described above can be modified as appropriate so long as the overall functionality of the model-code manager 401 and related components is performed or substantially performed as described herein.

The system used in connection with the invention may rely on the integration of various components including, as appropriate and/or if desired, hardware and software servers, applications software, database engines, firewalls, security, production back-up systems, and/or applications interface software. The configuration may be network-based, and optionally utilize the Internet as an exemplary primary interface with the customer for information delivery.

From the user's perspective, according to some embodiments the user may access the public Internet or other suitable network and look at its specific information at any time from any location as long as the user has Internet or other suitable access.

What is claimed is:

1. A computer implemented method for associating source code with a plurality of elements of a model representing the source code, comprising the steps of:
generating a plurality of elements of a model implementable as software source code;
generating the software source code corresponding to the plurality of elements of the model;
associating portions of the software source code with at least one of the plurality of elements of the model;
determining that at least one of the plurality of elements has been modified; and
modifying the source code to correspond to the at least one or more of the plurality of elements that has been modified.

2. The method according to claim 1, further comprising the step of displaying at least a portion of the source code that has been modified.

3. The method according to claim 1, wherein at least a portion of the model elements are displayed in a first display region of a browser, and at least a portion of the modified source code is displayed in a second display region of the browser.

4. The method according to claim 3, wherein particular line numbers of the source code are associated with the model elements.

5. The method according to claim 3, wherein the first and second display regions comprise frames.

6. The method according to claim 1, wherein particular line numbers of the source code are associated with the model elements.

7. The method according to claim 1, wherein the model elements are unified modeling language (UML) model elements.

8. The method according to claim 7, wherein the UML elements comprise at least one of a class diagram, an object diagram, a use case diagram, a state diagram, a sequence diagram, an activity diagram, a collaboration diagram, a component diagram, and a deployment diagram.

9. A computer implemented method for associating source code with a plurality of elements of a model representing the source code, comprising the steps of:
generating a plurality of elements of a model implementable as software source code;
generating the software source code corresponding to the plurality of elements of the model;
associating portions of the software source code with at least one of the plurality of elements of the model;
determining that at least a portion of the source code has been modified;
modifying the at least one of the plurality of model elements to correspond to the modified software source code; and
regenerating the software source code in accordance with predetermined rules so that the software source code conforms to the modified model.

10. The method according to claim 9, further comprising the step of displaying at least a portion of the software source code that has been modified.

11. The method according to claim 10, further comprising the step of displaying at least one of the plurality of elements of the model that has been modified.

12. The method according to claim 11, wherein at least one of the plurality of model elements is displayed in a first display region of a browser, and at least a portion of the modified software source code is displayed in a second display region of the browser.

13. The method according to claim 12, wherein particular line numbers of the software source code are associated with at least one of the plurality of model elements.

14. The method according to claim 12, wherein the first and second display regions comprise frames.

15. The method according to claim 11, wherein particular line numbers of the source code are associated with the model elements.

16. The method according to claim 11, wherein the model elements are unified modeling language (UML) model elements.

17. The method according to claim 16, wherein the UML elements comprise at least one of a class diagram, an object diagram, a use case diagram, a state diagram, a sequence diagram, an activity diagram, a collaboration diagram, a component diagram, and a deployment diagram.

18. A computer program product residing on a computer readable medium, the computer program product comprising instructions for causing a computer to:
generate a plurality of elements of a model implementable as software source code;
generate software source code corresponding to the plurality of elements of the model;
associate portions of the software source code with at least one of the plurality of elements of the model;
determine that at least one of the plurality of elements of the model has been modified; and
modify the source code to correspond to the one or more modified model elements.

19. The computer program product according to claim 18, further comprising instructions for causing the computer to display at least a portion of the source code that has been modified.

20. A computer program product residing on a computer readable medium, the computer program product comprising instructions for causing a computer to:
generate a plurality of elements of a model implementable as software source code;
generate software source code corresponding to the plurality of elements of the model;
associate portions of the software source code at least one of the plurality of elements of the model;
determine that at least a portion of the software source code has been modified;
modify the at least one of the plurality of model elements to correspond to the modified source code; and
regenerate the software source code in accordance with predetermined rules so that the source code conforms to the modified model.

21. The computer program product according to claim 20, further comprising instructions for causing a computer to display at least a portion of the source code that has been modified.

22. A data processing system for generating documentation for source code in a software project, comprising:
means for generating a plurality of elements of a model implementable as software source code;
means for generating software source code corresponding to the plurality of elements of the model;
means for associating portions of the software source code with at least one of the plurality of elements of the model;
means for determining that at least one of the plurality of elements of the model has been modified; and
means for modifying the software source code to correspond to one or more of the modified model elements.

23. The data processing system according to claim 22, further comprising means for displaying at least a portion of the source code that has been modified.

24. A computer implemented method for associating source code with a plurality of elements of a model representing the source code, comprising the steps of:
generating a plurality of elements of a model implementable as software source code;
generating software source code corresponding to the plurality of elements of the model;
associating portions of the software source code with at least one of the plurality of elements of the model;
determining that at least a portion of the software source code has been modified;
modifying the at least one of the plurality of model elements to correspond to the modified software source code; and
regenerating the software source code in accordance with predetermined rules so that the source code conforms to the modified model.

25. The computer implemented method according to claim 24, further comprising the step of displaying at least a portion of the source code that has been modified.
